(19) United States
(12) Patent Application Publication
(10) Pub. No.: US 2015/0074826 A1
(43) Pub. Date: Mar. 12, 2015

(54) AUTHORIZATION INFORMATION MANAGEMENT SYSTEM, ELECTRONIC DEVICE AND METHOD FOR MANAGING AUTHORIZATION INFORMATION

(71) Applicant: KABUSHIKI KAISHA TOSHIBA, Tokyo (JP)

(72) Inventor: Eita SHUTO, Tokyo (JP)

(21) Appl. No.: 14/453,437

(22) Filed: Aug. 6, 2014

Related U.S. Application Data
(60) Provisional application No. 61/876,900, filed on Sep. 12, 2013.

(51) Int. Cl. H04L 29/06; H04N 21/258; G06F 21/62

(52) U.S. Cl. CPC H04L 63/10; G06F 21/62; H04N 21/25875
USPC 726/28

(57) ABSTRACT

According to one embodiment, an authorization information management system has a first electronic device and a second electronic device. The first electronic device and the second electronic device are configured to communicate with each other. The first electronic device is configured to store first authorization information in the second electronic device and not in the first electronic device. The first authorization information the first authorization information is indicative of authorization by a user to access data used for a service provided by a server on a network and is issued to an application installed on the first electronic device by the server.

### CROSS-REFERENCE TO RELATED APPLICATIONS

This application claims the benefit of U.S. Provisional Patent Application No. 61/876,900, filed Sep. 12, 2013; the entire contents of which are incorporated herein by reference.

### FIELD

Embodiments described herein relates generally to an authorization information management system, an electronic device, and a method for managing authorization information.

### BACKGROUND

Conventionally, there has been known a technology in which, when a user uses a service that requires certain authorization before use, the user inputs authorization information such as authentication information and personal information in an electronic device and accesses the service with this electronic device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating the entire configuration of an authorization information management system according to an embodiment;

FIG. 2 is an exemplary block diagram illustrating internal configurations of a television device and a tablet according to the embodiment;

FIG. 3 is an exemplary diagram illustrating an operating screen displayed on a display module of the tablet to operate the television device, according to the embodiment;

FIG. 4 is an exemplary diagram illustrating a first screen displayed on a display module of the television device according to the embodiment;

FIG. 5 is an exemplary diagram illustrating a second screen displayed on the display module of the television device according to the embodiment;

FIG. 6 is an exemplary schematic sequence diagram illustrating the procedure performed in the authorization information management system according to the embodiment;

FIG. 7 is an exemplary flowchart illustrating the procedure performed by the television device when an application on the television device uses a service on a server, according to the embodiment;

FIG. 8 is an exemplary flowchart illustrating the procedure performed by the tablet when a refresh token is stored in the tablet, according to the embodiment; and

FIG. 9 is an exemplary flowchart illustrating the procedure performed by the tablet when the refresh token is transmitted from the tablet to the television device, according to the embodiment.

### DETAILED DESCRIPTION

In general, according to one embodiment, an authorization information management system comprises a first electronic device and a second electronic device. The first electronic device and the second electronic device are configured to communicate with each other. The first electronic device is configured to store first authorization information in the second electronic device and not in the first electronic device. The first authorization information the first authorization information is indicative of authorization by a user to access data used for a service provided by a server on a network and is issued to an application installed on the first electronic device by the server.

The following describes the present embodiment in detail with reference to the accompanying drawings.

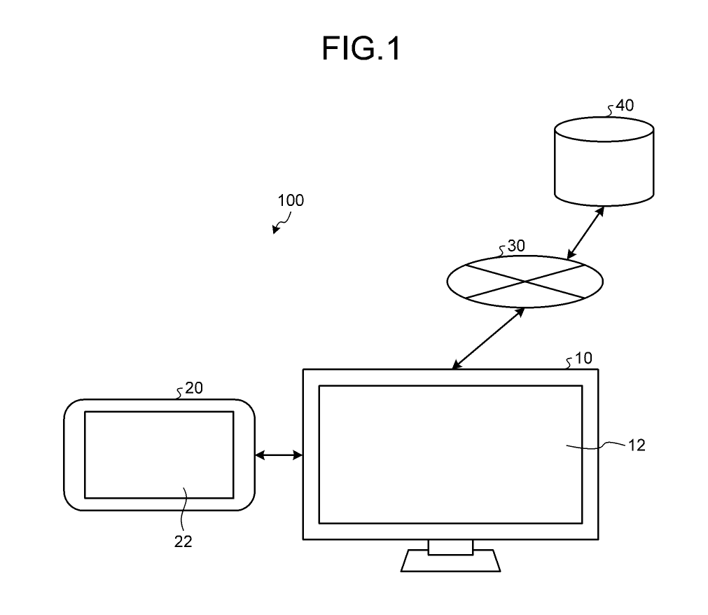

First, with reference to FIGS. 1 to 5, described is an example of a configuration of an authorization information management system 100 according to the embodiment.

As illustrated in FIG. 1, the authorization information management system 100 comprises a television device 10 and a tablet 20. The television device 10 is an example of an “electronic device”, and an example of the “first electronic device”. The tablet 20 is an example of “another electronic device”, and an example of the “second electronic device”.

The television device 10 is connected to a server 40 via a network 30 such as the Internet. The server 40 is configured to perform a service to provide external applications with an application programming interface (API) according to a protocol called OAuth to be described later via the network 30.

The television device 10 and the tablet 20 are communicably connected to each other. Specifically, the television device 10 is configured to communicate with the tablet 20 on the basis of a wireless communication standard (such as Wi-Fi Direct [registered trademark]) that does not require an access point such as a router, so that the television device 10 can transmit and receive various types of data (such as a refresh token to be described later) to and from the tablet 20.

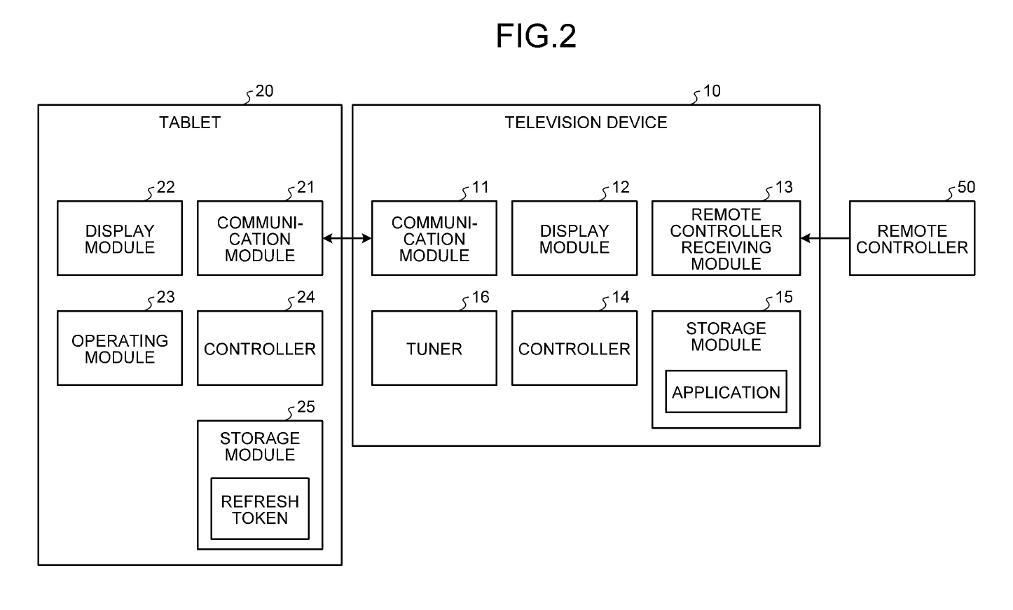

As illustrated in FIG. 2, the television device 10 comprises a communication module 11, a display module 12, a remote controller receiving module 13, a controller 14, a storage module 15, and a tuner 16. The tablet 20 comprises a communication module 21, a display module 22, an operating module 23, a controller 24, and a storage module 25.

The communication module 11 of the television device 10 is connected to the server 40 (see FIG. 1) via the network 30 (see FIG. 1). The communication module 11 is communicably connected to the communication module 21 of the tablet 20. The display module 12 of the television device 10 is configured to display video images such as a moving image and a static image.

The remote controller receiving module 13 of the television device 10 is configured to receive a remote controller signal transmitted by a remote controller 50 that is used to operate the television device 10. The controller 14 of the television device 10 is configured to control each module of the television device 10.

The storage module 15 of the television device 10 is provided for storing various computer programs (such as an application to be described later) executed by the controller 14, and various types of data used to execute these computer programs. The storage module 15 comprises a main memory such as a read only memory (ROM) and a random access memory (RAM), and an auxiliary memory such as a hard disk drive (HDD) and a solid state drive (SSD). The tuner 16 of the television device 10 is provided for receiving broadcast waves transmitted from broadcasting stations (not illustrated).

The communication module 21 of the tablet 20 is communicably connected to the communication module 11 of the television device 10. The display module 22 of the tablet 20 is configured to display video images such as a static image and a moving image. The operating module 23 of the tablet 20 functions as an input module used by the user operating the tablet 20. The operating module 23 comprises devices such as a touch panel using the display module 22, for example.

The controller 24 of the tablet 20 is configured to control each module of the tablet 20. The storage module 25 of the tablet 20 is provided for storing various computer programs executed by the controller 24, and various types of data used to execute these computer programs.

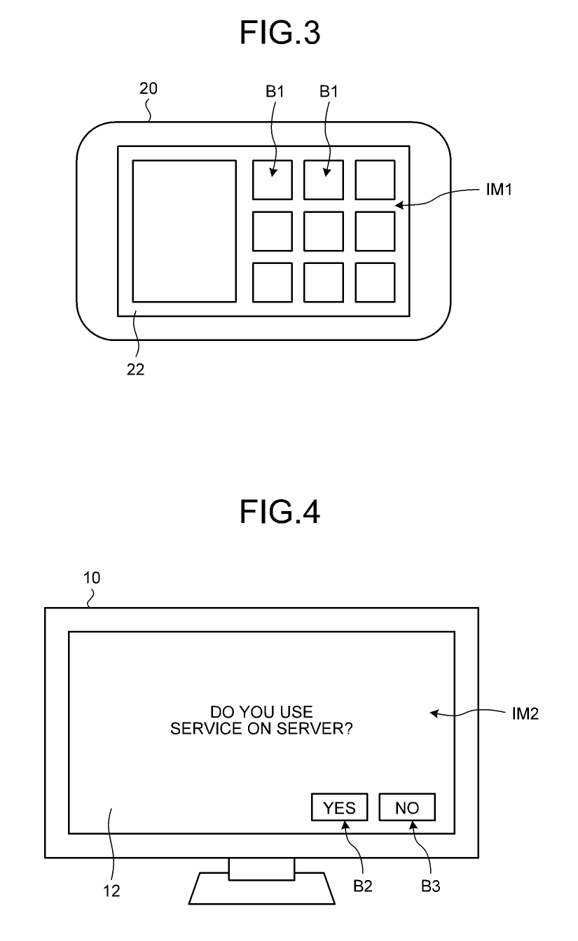

In the present embodiment, an application which enables the tablet 20 to operate the television device 10 is installed on the tablet 20. In other words, as illustrated in FIG. 3, the tablet 20 is configured to be able to display an operating screen IM1 comprising a plurality of buttons B1 for operating the television device 10 on the display module 22. Thus, the user can call computer programs such as the application to be described later installed on the television device 10 with the tablet 20. The operating screen IM1 illustrated in FIG. 3 is given for illustrative purpose only, and the present embodiment is not limited to this.

In the present embodiment, an application that can operate with services provided by the server 40 is installed on the television device 10. This application is configured to access the API provided by the server 40, so that the application can obtain, from the server 40, data used for a service on the server 40.

When the application accesses the server 40 as described above, authentication information such as a user ID and a password for logging on the server 40 is required in many cases. If the authentication information is stored in the television device 10, the application on the television device 10 can access all the data in the server 40, which is undesirable from a security point of view. Thus, a protocol called OAuth has been developed to make it possible to authorize and give permission to the application for accessing only data used for a target service on the server 40 without opening all the data on the server 40 to the outside.

In OAuth, a user determines whether to authorize and give the permission to the application for accessing such data described above. When the user authorizes and gives the permission to the application for accessing such data, the server 40 issues data called a refresh token (first authorization information) to the application. The application proves to the server 40 that the user has authorized and given the permission to the application for accessing data used for the target service, by transmitting the refresh token to the server 40. When receiving the refresh token from the application, the server 40 issues an access token (second authorization information) indicating that the server 40 has authorized the application to obtain data used for the target service, and transmits the issued access token to the application. After receiving the access token from the server 40, the application continuously obtains the data used for the target service from the server 40 by using the access token.

In the present embodiment, the television device 10 (the controller 14) is configured to store the refresh token not in the storage module 15 of the television device 10 but in the storage module 25 of the tablet 20 when receiving the refresh token from the server 40.

Specifically, the application on the television device 10 is configured to ask, when using a service (a first service: a service to be used for the first time, for example) that does not correspond to the refresh token that was previously stored in the tablet 20, the user to authorize and give permission to the application for accessing data used for the first service. The application on the television device 10 is configured to obtain the refresh token corresponding to the first service from the server and to transmit the obtained refresh token to the tablet 20 when the user authorizes and gives the permission to the application for accessing the data used for the first service. The tablet 20 is configured to store, when receiving the refresh token from the television device 10, therein the received refresh token.

More specifically, the application on the television device 10 is configured to ask the user whether to use a service provided by the server 40 by displaying a first screen IM2 illustrated in FIG. 4 on the display module 12. The first screen IM2 displays a message asking the user whether to use the service on the server 40, and a “YES” button B2 and a “NO” button B3 as illustrated in FIG. 4.

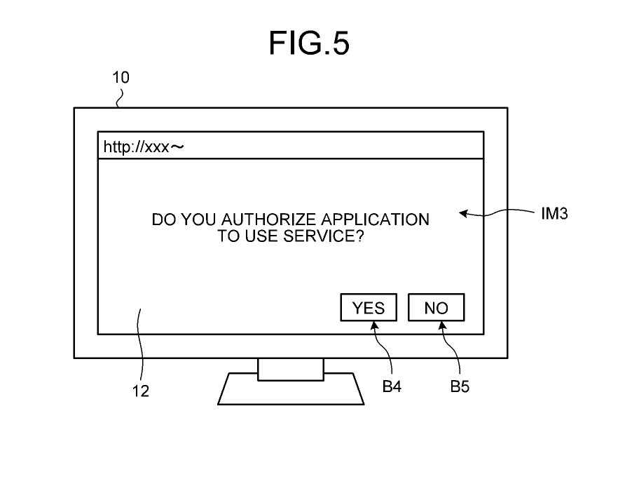

When the user performs pressing (touching) operation on the “YES” button B2 on the first screen IM2, the user is redirected (transferred) to a web page provided by the server 40, and the display module 12 of the television device 10 displays a second screen IM3 illustrated in FIG. 5. The second screen IM3 displays a message asking the user to authorize the application on the television device 10 to use the service (to give permission for accessing data used for the service), and a “YES” button B4 and a “NO” button B5 as illustrated in FIG. 5. When such redirection is performed, the application on the television device 10 transmits, to the server 40, a client ID that is identification information specific to the application and a client secret that is a secret key, so that the server 40 can specify the application to be authorized and given the permission by the user for accessing the data used for the service.

When the user performs pressing (touching) operation on the “YES” button B4 on the second screen IM3, the server 40 issues the refresh token to the application on the television device 10, and transmits the issued refresh token to the television device 10. The application on the television device 10 then transmits the refresh token received from the server 40 to the tablet 20 without storing it in the storage module 15 of the television device 10. The tablet 20 stores the refresh token received from the television device 10 in the storage module 25.

In the present embodiment, the application on the television device 10 is configured to request, when using a service (a second service: a service that the application has used one or more times) corresponding to the refresh token previously stored in the tablet 20, the tablet 20 to transmit the refresh token corresponding to the second service to the television device 10. The tablet 20 is configured to read out the refresh token corresponding to the second service from the storage module 25 and to transmit it to the television device 10 when the television device requests the tablet 20 to transmit the refresh token.

In the present embodiment, the application on the television device 10 is configured to obtain the access token (second authorization information) from the server 40 by transmitting, to the server 40, the refresh token thus received from the tablet 20. The application on the television device 10 is configured to transmit the client ID and the client secret to the server 40 when requesting the server 40 to issue the access token. Thus, the server 40 can specify the application to which the server 40 transmits the access token. The application on the television device 10 is configured to obtain, after receiving the access token from the server 40, target data from the server 40 by transmitting the received access token to the server 40.

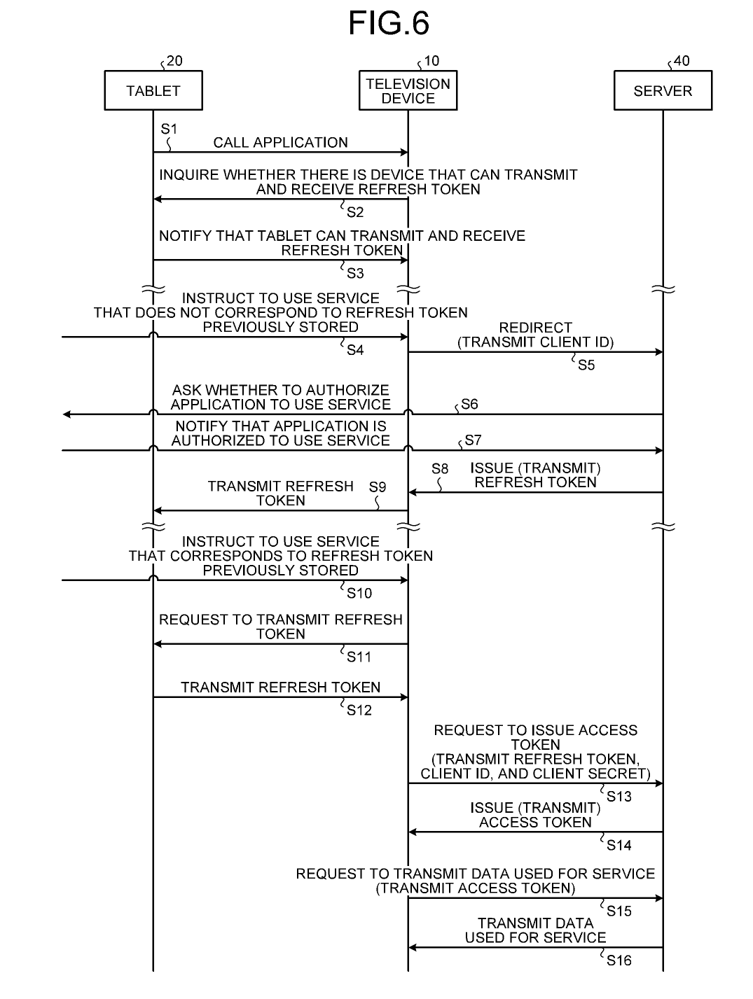

With reference to FIG. 6, the following schematically describes an example of the procedure performed by the television device 10, the tablet 20, and the server 40 in the authorization information management system 100 according to the present embodiment.

First, as illustrated in FIG. 6, assume that a user calls the application (application that can operate with a service on the server 40) on the television device 10 by the user's operation using the tablet 20 at S1. Such calling operation is performed on the operating screen IM1 illustrated in FIG. 3.

After S1, the television device 10 inquires, at S2, whether there is an device (the tablet 20 in the present embodiment) that can transmit and receive the refresh token. When receiving such an inquiry, the tablet 20 notifies the television device 10 at S3 that the tablet 20 can transmit and receive the refresh token. This establishes communication (communication conforming to Wi-Fi Direct [registered trademark]) between the television device 10 and the tablet 20.

Next, described is a case in which the user instructs, at S4, the television device 10 (application) to use a service (the first service: a service to be used for the first time, for example) that does not correspond to the refresh token previously stored in the tablet 20. Such instruction is performed on the first screen IM2 illustrated in FIG. 4 on the basis of operation by the user.

In this case, because the tablet 20 does not store the refresh token indicating that the user has authorized the application on the television device 10 to give permission for accessing data used for the service, the user is redirected (transferred), at S5, to a predetermined web page (a web page containing a message asking the user to authorize and give the permission to the application on the television device 10 for accessing the data used for the service) provided by the server 40. At this time, the television device 10 transmits the client ID for specifying the application to the server 40. The display module 12 of the television device 10 then displays the second screen IM3 illustrated in FIG. 5.

At S6, the user is asked on the second screen IM3 (see FIG. 5) whether to authorize the application on the television device 10 to use the service (whether to give the application the permission for accessing the data used for the service). When the user pushes the “YES” button B4 (see FIG. 5) on the second screen IM3 to authorize the application on the television device 10 to give the permission for accessing the data used for the service, the server 40 is notified, at S7, that the application on the television device 10 is authorized to use the service by the user. When thus notified, the server 40 issues (transmits) the refresh token to the application on the television device 10 at S8.

When receiving the refresh token issued (transmitted) by the server 40, the television device 10 transmits, at S9, the refresh token to the tablet 20 without storing it in the storage module 15 of the television device 10. When receiving the refresh token from the television device 10, the tablet 20 stores the refresh token in the storage module 25.

Next, described is a case in which the user instructs the television device 10 (application), at S10, to use a service (the second service: a service that has been used one or more times) corresponding to the refresh token previously stored in the tablet 20. Such instruction is performed on the first screen IM2 illustrated in FIG. 4 on the basis of operation by the user in the same manner described at S4.

In this case, because the tablet 20 stores the refresh token indicating that the user has authorized and given the permission to the application on the television device 10 for accessing data used for the service, the television device 10 requests the tablet 20 to transmit the refresh token used for the service to the television device 10 at S11.

When receiving such a request from the television device 10, the tablet 20 reads out the refresh token previously stored from the storage module 25 and transmits it to the television device 10 at S12. When receiving the refresh token from the tablet 20, the television device 10 requests to the server 40 to issue (transmit) the access token at S13. In addition, the television device 10 transmits to the server 40 the refresh token received from the tablet 20, and the client ID and the client secret stored in the storage module 15 at S13.

When receiving the request to issue the access token from the television device 10, the server 40 issues (transmits), at S14, the access token in accordance with the request to the television device 10. At S15, the television device 10 requests the server 40 to transmit data used for the target service by transmitting the received access token to the server 40. When receiving such a request from the television device 10, the server 40 transmits, at S16, data in accordance with the request (the data used for the target service) to the television device 10.

Such a refresh token management procedure described above is terminated when communication between the tablet 20 and the television device 10 is shut down because the tablet 20 is too distant from the television device 10 to communicate, for example.

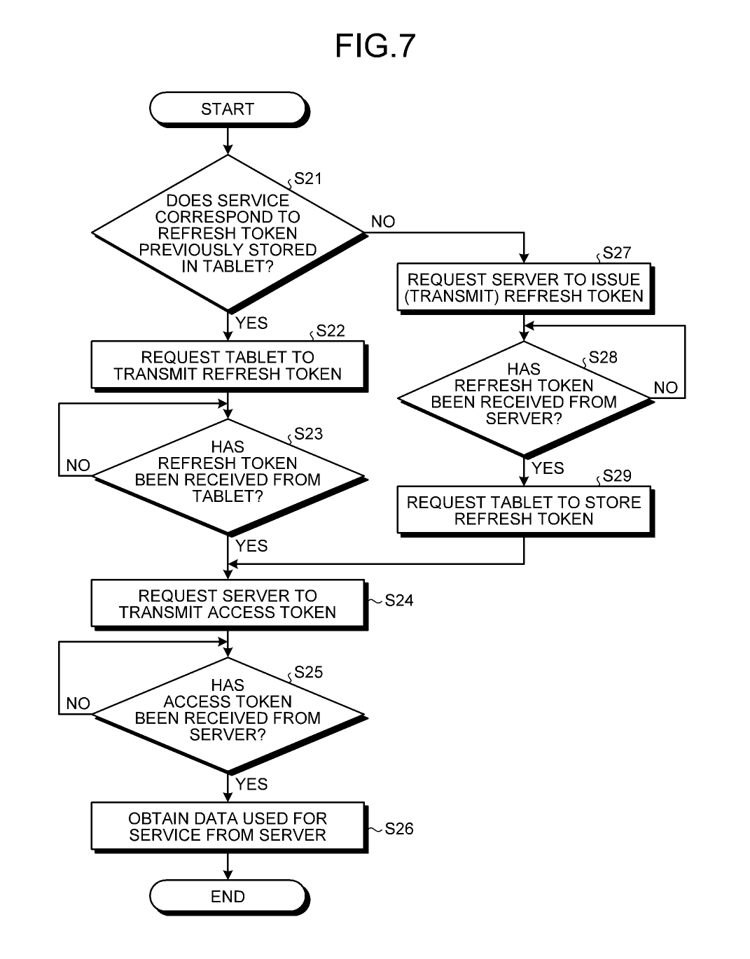

With reference to FIG. 7, the following describes an example of the procedure performed by the television device 10 when the application on the television device 10 uses a service provided by the server 40, according to the embodiment. This procedure starts when the user instructs the application to use the service on the server 40 by pushing (touching) the “YES” button B2 on the first screen IM2 illustrated in FIG. 4.

As illustrated in FIG. 7, the television device 10 determines, at S21, whether the service that the user has instructed the television device 10 (application) to use is a service (a service that has been used one or more times) that corresponds to the refresh token previously stored in the tablet 20.

When the television device 10 determines at S21 that the service that the user has instructed the television device 10 (application) to use is the service that corresponds to the refresh token previously stored in the tablet 20, the process proceeds to S22. At S22, the television device 10 requests the tablet 20 to transmit the refresh token to the television device 10, and the process proceeds to S23.

At S23, the television device 10 determines whether the refresh token has been received from the tablet 20. The television device 10 repeats the processing at S23 until the television device 10 determines that the refresh token has been received from the tablet 20. When the television device 10 determines that the refresh token has been received from the tablet 20 at S23, the process proceeds to S24.

At S24, the television device 10 requests the server 40 to issue (transmit) the access token using the refresh token received from the tablet 20. Together with the request to issue (transmit) the access token, the television device 10 transmits, at S24, the client ID and the client secret that are stored in the storage module 15 to the server 40, and the process proceeds to S25.

At S25, the television device 10 determines whether the access token has been received from the server 40. The television device 10 repeats the processing at S25 until the television device 10 determines that the access token has been received from the server 40. When the television device 10 determines that the access token has been received from the server 40 at S25, the process proceeds to S26.

At S26, the television device 10 obtains data used for the target service from the server 40 on the basis of the access token received from the server 40. Specifically, the television device 10 transmits the access token together with a request to provide data to the server 40, so that the television device 10 obtains target data in exchange of the access token. When the television device 10 receives the target data, the procedure is completed.

When the television device 10 determines, at S21, whether the service that the user has instructed the television device 10 (application) to use is a service (a service to be used for the first time, for example) that does not correspond to the refresh token previously stored in the tablet 20, the process proceeds to S27.

At S27, the television device 10 requests the server 40 to issue (transmit) the refresh token corresponding to the service that the user has instructed the television device 10 (application) to use. Specifically, the user is redirected to a predetermined web page (a web page containing a message asking the user to authorize and give the permission to the application on the television device 10 for accessing data corresponding to the service) provided by the server 40. More specifically, the television device 10 displays the second screen IM3 illustrated in FIG. 5 on the display module 12. When the user pushes the “YES” button B4 (see FIG. 5) on the second image IM3 to authorize and give the permission to the application on the television device 10, the process proceeds to S28.

At S28, the television device 10 determines whether the refresh token has been received from the server 40. The refresh token to the application on the television device 10 is issued by the server when the user performs operation on the second screen IM3 (see FIG. 5) to authorize and give permission to the application on the television device 10 for accessing data used for the service. The television device 10 repeats the processing at S28 until the television device 10 determines that the refresh token has been received from the server 40. When the television device 10 determines at S28 that the refresh token has been received from the server 40, the process proceeds to S29.

At S29, the television device 10 requests the tablet 20 to store the refresh token received from the server 40. Thus, the refresh token is stored not in the storage module 15 of the television device 10 but in the storage module 25 of the tablet 20.

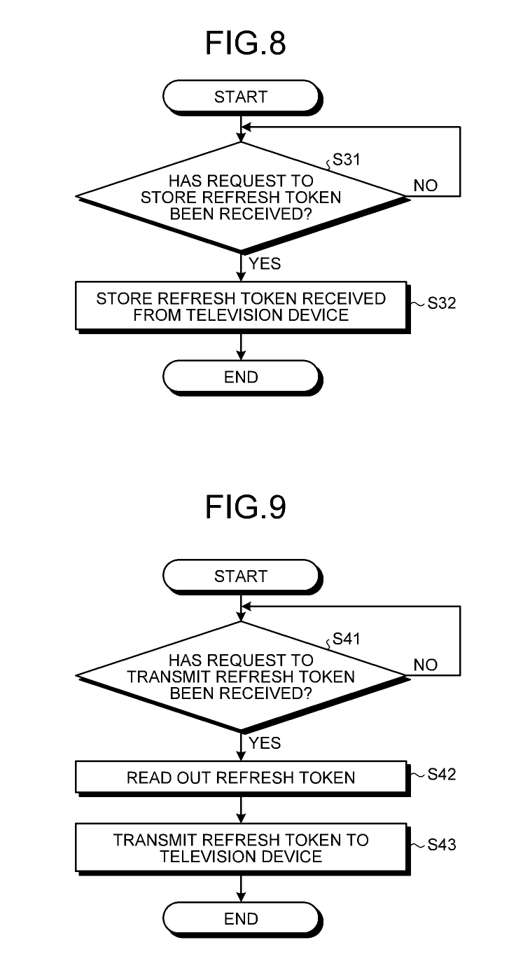

Next, with reference to FIG. 8, described is an example of the procedure performed by the tablet 20 when the tablet 20 stores the refresh token, according to the embodiment. This procedure is started when the television device 10 performs the processing at S29 illustrated in FIG. 7.

First, as illustrated in FIG. 8, the tablet 20 determines at S31 whether a request to store the refresh token (a request made by the television device 10 after performing the processing at S29 illustrated in FIG. 7) has been received from the television device 10. The tablet 20 repeats the processing at S31 until the tablet 20 determines that the request to store the refresh token has been received from the television device 10. When the tablet 20 determines at S31 that the request to store the refresh token has been received from the television device 10, the process proceeds to S32.

At S32, the tablet 20 stores the refresh token received from the television device 10 together with the request in the storage module 25, and completes the procedure.

Next, with reference to FIG. 9, described is an example of the procedure performed by the tablet 20 according to the embodiment when the tablet 20 transmits the refresh token to the television device 10. This procedure is started when the television device 10 performs the processing at S22 illustrated in FIG. 7.

First, as illustrated in FIG. 9, the tablet 20 determines at S41 whether a request to transmit the refresh token (a request made by the television device 10 when the television device 10 performs the processing at S22 illustrated in FIG. 7) has been received from the television device 10. The tablet 20 repeats the processing at S41 until the tablet 20 determines that the request to transmit the refresh token has been received from the television device 10. When the tablet 20 determines at S41 that the request to transmit the refresh token has been received from the television device 10, the process proceeds to S42.

At S42, the tablet 20 reads out the refresh token specified by the request from the storage module 25, and the process proceeds to S43. At S43, the tablet 20 transmits the refresh token thus read out to the television device 10, and completes the procedure.

As described above, in the present embodiment, the television device 10 (controller 14) is configured to store the refresh token issued by the server 40 not in the television device 10 but in the tablet 20. The refresh token is information (first authorization information) issued by the server 40 on the network 30 to the application installed on the television device 10 when the user authorizes and gives the permission to the application for accessing data used for the service provided by the server 40. This enables the user to store the refresh token in another device (tablet 20) other than the television device 10 to manage the refresh token, for example. This is particularly effective in sharing one television device by a plurality of users, or in handing over a service environment between two or more television devices that are different from each other, for example.

In the present embodiment, as described above, the application installed on the television device 10 is configured to ask, when using a service (first service: a service to be used for the first time, for example) that does not correspond to the refresh token previously stored in the tablet 20, the user to authorize and give permission to the application for accessing data used for the first service. The application is configured to obtain the refresh token corresponding to the first service from the server and to transmit the refresh token to the tablet 20 when the user authorizes and gives the permission to the application t for accessing the data corresponding to the first service. The tablet 20 is configured to store, when receiving the refresh token from the application, the received refresh token in the storage module 25. This enables the user to easily store the refresh token in another device (tablet 20) other than the television device 10 to manage the refresh token, for example.

In the present embodiment, as described above, the application installed on the television device 10 is configured to request, when using a service (second service: a service that has been used one or more times) corresponding to the refresh token previously stored in the tablet 20, the tablet 20 to transmit the refresh token corresponding to the second service. The tablet 20 is configured to transmit, when receiving such a request from the television device 10, the refresh token stored in the storage module 25 to the television device 10. This enables the tablet 20 to transmit the required refresh token to the television device 10 when needed, for example.

In the present embodiment, as described above, the application installed on the television device 10 is configured to obtain the access token from the server 40 by transmitting the refresh token to the server. The application is configured to obtain data used for the service from the server 40 by transmitting the obtained access token to the server 40. The access token is information (second authorization information) indicating that the server has authorized the application to obtain the data used for the service. This enables the application to easily obtain the access token required when the application obtains the data on the server 40, for example.

In the embodiment described above, although a television device is given as an example of the “electronic device (first electronic device)”, an electronic device (a recording device that outputs a video image to the television device, or a video device such as a set-top box, for example) may be given as the “electronic device (first electronic device)” in another embodiment. In the same manner, although a tablet is given as an example of “another electronic device (second electronic device)” in the embodiment described above, a mobile information terminal (such as a smartphone) other than the tablet, or an electronic device (such as a personal computer) other than the mobile information terminal may be given as “another electronic device (second electronic device)” in another embodiment.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An authorization information management system comprising:
a first electronic device and a second electronic device, wherein
the first electronic device and the second electronic device are configured to communicate with each other, and
the first electronic device is configured to store first authorization information in the second electronic device and not in the first electronic device, the first authorization information indicative of authorization by a user to access data used for a service provided by a server on a network and issued to an application installed on the first electronic device by the server.

2. The authorization information management system of claim 1, wherein
the application is configured to request that the user authorize the application to access data used for a first service when using the first service, the first service not corresponding to the first authorization information stored in the second electronic device,
the application is configured to obtain from the server the first authorization information corresponding to the first service and to transmit the obtained first authorization information to the second electronic device when the user authorizes the application, and
when the second electronic device receives the first authorization information from the application, the second electronic device is configured to store the received first authorization information.

3. The authorization information management system of claim 1, wherein
the application is configured to request that the second electronic device transmit the first authorization information corresponding to a second service when using the second service, the second service corresponding to the first authorization information stored in the second electronic device, and
the second electronic device is configured to transmit the first authorization information corresponding to the second service to the first electronic device when the application requests that the second electronic device transmit the first authorization information corresponding to the second service.

4. The authorization information management system of claim 1, wherein
the application is configured to obtain second authorization information from the server by transmitting the first authorization information to the server, the second authorization information indicative of authorization by the server to the application to obtain data used for the service, and
the application is configured to obtain the data from the server by transmitting the obtained second authorization information to the server.

5. An electronic device configured to communicate with another electronic device, the electronic device comprising:
a controller configured to store authorization information in the another electronic device and not in the electronic device, the authorization information indicative of authorization by a user to access data used for a service provided by a server on a network and issued to an application installed on the electronic device by the server.

6. A method for managing authorization information, the method comprising:
using a first electronic device comprising computer hardware, storing authorization information in a second electronic device and not in the first electronic device, the first electronic device and the second electronic device configured to communicate with each other, the authorization information indicative of authorization by a user to access data used for a service provided by a server on a network and issued to an application installed on the first electronic device by the server.
